(19) United States
(12) Patent Application Publication
(10) Pub. No.: US 2022/0204345 A1
(43) Pub. Date: Jun. 30, 2022

(54) PROCESS FOR PREPARING BIS(FLUOROSULFONYL) IMIDE

(71) Applicant: ARKEMA FRANCE, Colombes (FR)

(72) Inventor: Dominique DEUR-BERT, PIERRE-BENITE CEDEX (FR)

(21) Appl. No.: 17/604,929

(22) PCT Filed: Apr. 21, 2020
(86) PCT No.: PCT/EP2020/061064

§ 371 Date: Oct. 19, 2021

(30) Foreign Application Priority Data
Apr. 25, 2019 (FR) 1904384

(51) Int. Cl. C01B 21/093; B01J 14/00

(52) U.S. Cl. CPC C01B 21/0935; B01J 2204/002; B01J 14/00

(57) ABSTRACT

The invention relates to a process for preparing bis(fluorosulfonyl) imide, comprising the steps of: i) providing a stream A1 containing hydrofluoric acid; providing a reactor containing a liquid phase A2 that contains bis(halosulfonyl) imide; providing at least one mixing device that is connected to the inlet of said reactor; ii) supplying liquid phase A2 and stream A1 to the at least one mixing device; iii) bringing liquid phase A2 into contact with stream A1 in the mixing device to form a reaction mixture B in liquid form containing bis(fluorosulfonyl) imide; iv) introducing the reaction mixture B produced in step iii) into the liquid phase A2 in the reactor.

### TECHNICAL FIELD

The present invention relates to a process for preparing bis(fluorosulfonyl)imide. In particular, the present invention relates to a process for preparing bis(fluorosulfonyl)imide from bis(halosulfonyl)imide.

### PRIOR ART

By virtue of their very low basicity, anions of sulfonylimide type are increasingly used in the field of energy storage in the form of inorganic salts in batteries, or of organic salts in supercapacitors or in the field of ionic liquids. Since the battery market is booming and the reduction of battery manufacturing costs is becoming a major issue, a large-scale, low-cost synthesis process for anions of this type is required.

In the specific field of Li-ion batteries, the salt that is currently the most widely used is LiPF₆, but this salt has many drawbacks such as limited thermal stability, sensitivity to hydrolysis and thus lower safety of the battery. Recently, novel salts bearing the group FSO₂⁻ have been studied and have demonstrated many advantages such as better ion conductivity and resistance to hydrolysis. One of these salts, LiFSI (LiN(FSO₂)₂), has shown highly advantageous properties which make it a good candidate for replacing LiPF₆.

There are various methods for preparing LiFSI. WO2009/123328 describes in particular the preparation of LiFSI from bis(chlorosulfonyl)imide, via various steps of preparing intermediate salts, such as for example a zinc bis(fluorosulfonyl)imide salt, followed by an ammonium bis(fluorosulfonyl)imide salt.

One of the reaction intermediates for attaining LiFSI is bis(fluorosulfonyl)imide. WO 2015/012897 describes the preparation of bis(fluorosulfonyl)imide by fluorination of bis(halosulfonyl) in the presence of hydrofluoric acid. The preparation of bis(fluorosulfonyl)imide, (HFSI), is obtained under hydrofluoric acid reflux conditions. Carrying out the process under these conditions can promote the formation of unwanted by-products. Moreover, the operating conditions applied in this process require a significant energy input which increases the carbon footprint of this process.

There is therefore still a need for a process for preparing bis(fluorosulfonyl)imide which does not have the abovementioned drawbacks.

### SUMMARY OF THE INVENTION

According to a first aspect, the present invention provides a process for preparing bis(fluorosulfonyl)imide comprising the steps of:

i)—providing a stream A1 comprising hydrofluoric acid;
providing a reactor containing a liquid phase A2 comprising bis(halosulfonyl)imide;
providing at least one mixing device connected to the inlet of said reactor;

ii) supplying said at least one mixing device with the liquid phase A2 and with said stream A1;

iii) bringing, in said mixing device, said liquid phase A2 into contact with said stream A1, in order to form a reaction mixture B comprising bis(fluorosulfonyl)imide;

iv) introducing the reaction mixture B produced in step iii) into the liquid phase A2 of said reactor.

According to a preferred embodiment, the process is carried out in batch mode and the liquid phase A2 contained in said reactor is withdrawn, preferably continuously, to supply said at least one mixing device in step ii).

According to a preferred embodiment, said process comprises step v) of repeating steps ii) to iv) until a liquid phase A2 comprising at least 95% by weight of bis(fluorosulfonyl)imide is obtained. According to a preferred embodiment, the hydrofluoric acid is in gaseous form and said at least one mixing device is a water scrubber.

According to a preferred embodiment, the hydrofluoric acid is in liquid form and said at least one mixing device is a static mixer.

According to a second aspect, the present invention provides a process for preparing bis(fluorosulfonyl)imide comprising the steps of:

i′)—providing a stream A1 comprising hydrofluoric acid;
providing a liquid phase A2 comprising bis(halosulfonyl)imide;
providing at least one mixing device and a separator, said mixing device being connected to the inlet of said separator;

ii′) continuously supplying said at least one mixing device with the liquid phase A2 and with said stream A1;

iii′) bringing, in said mixing device, said liquid phase A2 into contact with said stream A1, in order to form a reaction mixture C, in liquid form, comprising bis(fluorosulfonyl)imide;

iv′) introducing the reaction mixture C produced in step iii′) into said separator.

According to a preferred embodiment, the hydrofluoric acid is in liquid form and said at least one mixing device is a static mixer.

According to a preferred embodiment, said liquid phase A2 and said stream A1 co-currently supply said mixing device. This makes it possible to improve the efficiency of the process.

According to a preferred embodiment, during step iii) or during step iii′), a compound of formula HX is produced, X being Cl, Br or I and the reaction mixture B or the reaction mixture C comprises, besides bis(fluorosulfonyl)imide, said compound HX.

According to a preferred embodiment, said process comprises a step iv″) subsequent to step iv) during which the compound of formula HX is removed from said reactor or a step iv″) subsequent to step iv′) during which the compound of formula HX is removed from said separator.

According to a preferred embodiment, the rate of introduction of the hydrofluoric acid contained in said stream A1 into said at least one mixing device is at least 1 mol of HF/mole of bis(halosulfonyl)imide/hour and preferably at most 300 mol of HF/mole of bis(halosulfonyl)imide/hour.

According to a preferred embodiment, step iii) or step iii′) is carried out with an HF/[bis(halosulfonyl)imide] molar ratio of at least 2.0 and at most 3.0.

According to a preferred embodiment, the bis(halosulfonyl)imide compound is bis(chlorosulfonyl)imide.

According to a third aspect, the present invention provides a process for preparing lithium bis(fluorosulfonyl)imide salt comprising the steps:

a) carrying out the bis(fluorosulfonyl)imide preparation process according to the present invention;

b) bringing the bis(fluorosulfonyl)imide into contact with a composition comprising at least one lithium salt in order to form said lithium bis(fluorosulfonyl)imide salt.

According to a fourth aspect, the present invention provides a plant for carrying out the bis(fluorosulfonyl)imide preparation process comprising:
a reactor containing a liquid phase A2 comprising bis(halosulfonyl)imide;
a feed line for said liquid phase A2 connected to said reactor;
at least one mixing device, the outlet of which is connected to the inlet of said reactor;
a feed line for a stream A1 comprising hydrofluoric acid and connected to the inlet of said mixing device;
a pump connected to the outlet of said reactor;
an outlet line configured to extract the gases contained in the headspace of said reactor; and
a pipe connecting said pump to the inlet of said mixing device; and
optionally a heat exchanger positioned on said pipe and connected to said mixing device and to said pump.

According to a fifth aspect, the present invention provides a plant for carrying out the bis(fluorosulfonyl)imide preparation process comprising:
a separator and at least one mixing device, the outlet of said at least one mixing device being connected to the inlet of said separator;
a feed line for a liquid phase A2 comprising bis(halosulfonyl)imide connected to the inlet of said mixing device;
a feed line for a stream A1 comprising hydrofluoric acid and connected to the inlet of said mixing device;
a pump connected to the outlet of said separator;
an outlet line configured to extract the gases contained in the headspace of said separator; and
an outlet line connected to said pump.

### BRIEF DESCRIPTION OF THE FIGURES

FIG. 1 schematically represents a plant for carrying out, in batch mode, the process for preparing bis(fluorosulfonyl)imide according to one particular embodiment.

FIG. 2 schematically represents a plant for carrying out, in batch mode, the process for preparing bis(fluorosulfonyl)imide according to one particular embodiment in which two mixing devices are positioned in series.

FIG. 3 schematically represents a plant for carrying out, in continuous mode, the process for preparing bis(fluorosulfonyl)imide according to one particular embodiment.

FIG. 4 schematically represents a plant for carrying out, in continuous mode, the process for preparing bis(fluorosulfonyl)imide according to another particular embodiment.

### DETAILED DESCRIPTION OF THE INVENTION

According to a first aspect of the present invention, a process for preparing bis(fluorosulfonyl)imide is provided. Said process comprises the steps of:

i)—providing a stream A1 comprising hydrofluoric acid;
providing a reactor containing a liquid phase A2 comprising bis(halosulfonyl)imide;
providing at least one mixing device connected to said reactor;

ii) supplying said at least one mixing device with the liquid phase A2 and with said stream A1;

iii) bringing, in said mixing device, said liquid phase A2 into contact with said stream A1, in order to form a reaction mixture B comprising bis(fluorosulfonyl)imide;

iv) introducing the reaction mixture B produced in step iii) into the liquid phase A2 of said reactor.

Preferably, the liquid phase A2 consists of bis(halosulfonyl)imide.

Preferably, said liquid phase A2 and said stream A1 co-currently supply said mixing device. This makes it possible to improve the efficiency of the process.

Preferably, said bis(fluorosulfonyl)imide within said reaction mixture B is in liquid form. Preferably, in this first aspect of the invention, said process is carried out in batch mode, that is to say that the bis(fluorosulfonyl)imide is not recovered continuously. Thus, according to a preferred embodiment, the process is carried out in batch mode and the liquid phase A2 comprising the bis(halosulfonyl)imide is introduced initially into said reactor. According to a preferred embodiment, the process is carried out in batch mode and the liquid phase A2 contained in said reactor is withdrawn, preferably continuously, to supply said at least one mixing device in step ii).

Preferably, said stream A1 feeds said mixing device continuously.

Preferably, said liquid phase A2 comprises bis(halosulfonyl)imide but is free of organic solvent. Thus, step iii) of fluorinating the bis(halosulfonyl)imide to bis(fluorosulfonyl)imide is carried out in the absence of organic solvent.

According to an alternative particular embodiment, said liquid phase A2 comprises bis(halosulfonyl)imide and an organic solvent. The organic solvent SO1 can be chosen from esters, nitriles, ethers, aromatic solvents, carbonates, cyclic or heterocyclic solvents and mixtures thereof. Preferably, the organic solvent SO1 is chosen from the group consisting of methyl acetate, butyl acetate, ethyl acetate, propyl acetate, isopropyl acetate, butyronitrile, valeronitrile, benzonitrile, diisopropyl ether, 2-methoxy-2-methylbutane, cyclopentyl methyl ether, benzene, toluene, chlorobenzene, dichlorobenzene, xylenes, ethylbenzene, 1,4-dioxane, dimethyl carbonate, ethylene carbonate, sulfolane and mixtures thereof.

The hydrofluoric acid contained in said stream A1 reacts with the bis(halosulfonyl)imide contained in said liquid phase A2 to form the bis(fluorosulfonyl)imide. The bis(halosulfonyl)imide may be bis(chlorosulfonyl)imide, bis(bromosulfonyl)imide or bis(iodosulfonyl)imide or a mixture thereof. Preferably, in the present application, the bis(halosulfonyl)imide is bis(chlorosulfonyl)imide.

Preferably, the hydrofluoric acid is anhydrous hydrofluoric acid. In the context of the invention, the term “anhydrous hydrofluoric acid” is understood to mean HF containing less than 500 ppm of water, preferably less than 300 ppm of water and preferably less than 200 ppm of water. Preferably, step iii) is carried out under pressure and temperature conditions so as to keep the bis(halosulfonyl)imide and the bis(fluorosulfonyl)imide produced in liquid form.

Thus, step iii) may be carried out at atmospheric pressure or at a pressure greater than atmospheric pressure. Preferably, step iii) may be carried out at a pressure of less than 10 bara, advantageously at a pressure of less than 9 bara, preferably of less than 8 bara, more preferentially of less than 7 bara, in particular of less than 6 bara.

Step iii) may be carried out at a temperature above 0° C., advantageously above 5° C., preferably above 10° C., more preferentially above 15° C.

Preferably, step iii) is carried out at a temperature below 150° C., advantageously below 140° C., preferably below 130° C., more preferentially below 120° C., in particular below 110° C., more particularly below 100° C., favorably below 90° C., advantageously favorably below 80° C., preferentially favorably below 70° C., more preferentially favorably below 60° C., particularly favorably below 50° C.

Thus, step iii) may be carried out at a temperature above 0° C., advantageously above 5° C., preferably above 10° C., more preferentially above 15° C.; and at a temperature below 150° C., advantageously below 140° C., preferably below 130° C., more preferentially below 120° C., in particular below 110° C., more particularly below 100° C., favorably below 90° C., advantageously favorably below 80° C., preferentially favorably below 70° C., more preferentially favorably below 60° C., particularly favorably below 50° C.

Preferably, step iii) may be carried out at a temperature above 0° C., advantageously above 5° C., preferably above 10° C., more preferentially above 15° C.; and at a temperature below 150° C., advantageously below 140° C., preferably below 130° C., more preferentially below 120° C., in particular below 110° C., more particularly below 100° C., favorably below 90° C., advantageously favorably below 80° C., preferentially favorably below 70° C., more preferentially favorably below 60° C., particularly favorably below 50° C.; and at atmospheric pressure.

Preferably, step iii) may be carried out at a temperature above 0° C., advantageously above 5° C., preferably above 10° C., more preferentially above 15° C.; and at a temperature below 150° C., advantageously below 140° C., preferably below 130° C., more preferentially below 120° C., in particular below 110° C., more particularly below 100° C., favorably below 90° C., advantageously favorably below 80° C., preferentially favorably below 70° C., more preferentially favorably below 60° C., particularly favorably below 50° C.; and at a pressure of greater than 1 bara; and of less than 10 bara, advantageously at a pressure of less than 9 bara, preferably less than 8 bara, more preferentially less than 7 bara, in particular less than 6 bara.

Preferably, during steps ii), iii) and iv) the temperature of said liquid phase A2 is kept substantially constant. In the present application, the term “substantially constant” is understood to mean a temperature variation of at most 5° C. in absolute value, preferably of at most 3° C. in absolute value, more preferentially still of at most 2° C. in absolute value, or in particular of at most 1° C. in absolute value.

Thus, during steps ii), iii) and iv), the temperature of said liquid phase A2 varies by at most 5° C. in absolute value, preferably by at most 3° C. in absolute value, more preferentially still by at most 2° C. in absolute value, or in particular by at most 1° C. in absolute value.

Preferably, in step iii), the rate of introduction of the hydrofluoric acid contained in said stream A1 into said at least one mixing device is at least 1 mol of HF/mole of bis(halosulfonyl)imide/hour, advantageously at least 5 mol of HF/mole of bis(halosulfonyl)imide/hour, preferably at least 10 mol of HF/mole of bis(halosulfonyl)imide/hour, more preferentially at least 20 mol of HF/mole of bis(halosulfonyl)imide/hour, in particular at least 30 mol of HF/mole of bis(halosulfonyl)imide/hour, more particularly at least 40 mol of HF/mole of bis(halosulfonyl)imide/hour, favorably at least 50 mol of HF/mole of bis(halosulfonyl)imide/hour.

In particular, in step iii), the rate of introduction of the hydrofluoric acid contained in said stream A1 into said at least one mixing device is at most 300 mol of HF/mole of bis(halosulfonyl)imide/hour, advantageously at most 250 mol of HF/mole of bis(halosulfonyl)imide/hour, preferably at most 200 mol of HF/mole of bis(halosulfonyl)imide/hour, in particular at most 150 mol of HF/mole of bis(halosulfonyl)imide/hour, more particularly at most 125 mol of HF/mole of bis(halosulfonyl)imide/hour, favorably at most 100 mol of HF/mole of bis(halosulfonyl)imide/hour.

Thus, in step iii), the rate of introduction of the hydrofluoric acid contained in said stream A1 into said at least one mixing device is at least 1 mol of HF/mole of bis(halosulfonyl)imide/hour, advantageously at least 5 mol of HF/mole of bis(halosulfonyl)imide/hour, preferably at least 10 mol of HF/mole of bis(halosulfonyl)imide/hour, more preferentially at least 20 mol of HF/mole of bis(halosulfonyl)imide/hour, in particular at least 30 mol of HF/mole of bis(halosulfonyl)imide/hour, more particularly at least 40 mol of HF/mole of bis(halosulfonyl)imide/hour, favorably at least 50 mol of HF/mole of bis(halosulfonyl)imide/hour; and at most 300 mol of HF/mole of bis(halosulfonyl)imide/hour, advantageously at most 250 mol of HF/mole of bis(halosulfonyl)imide/hour, preferably at most 200 mol of HF/mole of bis(halosulfonyl)imide/hour, in particular at most 150 mol of HF/mole of bis(halosulfonyl)imide/hour, more particularly at most 125 mol of HF/mole of bis(halosulfonyl)imide/hour, favorably at most 100 mol of HF/mole of bis(halosulfonyl)imide/hour.

In particular, in step iii), the rate of introduction of the hydrofluoric acid contained in said stream A1 into said at least one mixing device is at least 1 mol of HF/mole of bis(chlorosulfonyl)imide/hour, advantageously at least 5 mol of HF/mole of bis(chlorosulfonyl)imide/hour, preferably at least 10 mol of HF/mole of bis(chlorosulfonyl)imide/hour, more preferentially at least 20 mol of HF/mole of bis(chlorosulfonyl)imide/hour, in particular at least 30 mol of HF/mole of bis(chlorosulfonyl)imide/hour, more particularly at least 40 mol of HF/mole of bis(chlorosulfonyl)imide/hour, favorably at least 50 mol of HF/mole of bis(chlorosulfonyl)imide/hour.

More particularly, in step iii), the rate of introduction of the hydrofluoric acid contained in said stream A1 into said at least one mixing device is at most 300 mol of HF/mole of bis(chlorosulfonyl)imide/hour, advantageously at most 250 mol of HF/mole of bis(chlorosulfonyl)imide/hour, preferably at most 200 mol of HF/mole of bis(chlorosulfonyl)imide/hour, in particular at most 150 mol of HF/mole of bis(chlorosulfonyl)imide/hour, more particularly at most 125 mol of HF/mole of bis(chlorosulfonyl)imide/hour, favorably at most 100 mol of HF/mole of bis(chlorosulfonyl)imide/hour.

Thus, in step iii), the rate of introduction of the hydrofluoric acid contained in said stream A1 into said at least one mixing device is at least 1 mol of HF/mole of bis(chlorosulfonyl)imide/hour, advantageously at least 5 mol of HF/mole of bis(chlorosulfonyl)imide/hour, preferably at least 10 mol of HF/mole of bis(chlorosulfonyl)imide/hour, more preferentially at least 20 mol of HF/mole of bis(chlorosulfonyl)imide/hour, in particular at least 30 mol of HF/mole of bis(chlorosulfonyl)imide/hour, more particularly at least 40 mol of HF/mole of bis(chlorosulfonyl)imide/hour, favorably at least 50 mol of HF/mole of bis(chlorosulfonyl)imide/hour; and at most 300 mol of HF/mole of bis(chlorosulfonyl)imide/hour, advantageously at most 250 mol of HF/mole of bis(chlorosulfonyl)imide/hour, preferably at most 200 mol of HF/mole of bis(chlorosulfonyl)imide/hour, in particular at most 150 mol of HF/mole of bis(chlorosulfonyl)imide/hour, more particularly at most 125 mol of HF/mole of bis(chlorosulfonyl)imide/hour, favorably at most 100 mol of HF/mole of bis(chlorosulfonyl)imide/hour.

The rate of introduction of the hydrofluoric acid mentioned above makes it possible to avoid losses of HF, in particular when the latter is introduced in gaseous form. This therefore makes it possible to improve the overall efficiency of the process.

In addition, the rate of introduction of the HF can be controlled so as to maintain a low stationary concentration of HF in the reaction medium, i.e. in said liquid phase A2. The HF will then be consumed immediately in the fluorination reaction and the molar ratio between the HF and the bis(halosulfonyl)imide will be close to stoichiometry.

Thus, according to a preferred embodiment, step iii) is carried out with an HF/[bis(halosulfonyl)imide] molar ratio of at least 2.0, preferably of at least 2.05, in particular of at least 2.1. Preferably, step iii) is carried out with an HF/[bis(halosulfonyl)imide] molar ratio of at most 3.5, preferably of at most 3.0, in particular of at most 2.5.

Thus, step iii) is carried out with an HF/[bis(halosulfonyl)imide] molar ratio of at least 2.0, preferably of at least 2.05, in particular of at least 2.1; and of at most 3.5, preferably of at most 3.0, in particular of at most 2.5.

Preferably, step iii) is carried out with an HF/[bis(chlorosulfonyl)imide] molar ratio of at least 2.0, preferably of at least 2.05, in particular of at least 2.1. Preferably, step iii) is carried out with an HF/[bis(chlorosulfonyl)imide] molar ratio of at most 3.5, preferably of at most 3.0, in particular of at most 2.5.

Thus, step iii) is carried out with an HF/[bis(chlorosulfonyl)imide] molar ratio of at least 2.0, preferably of at least 2.05, in particular of at least 2.1; and of at most 3.5, preferably of at most 3.0, in particular of at most 2.5.

According to a preferred embodiment, said process comprises step v) of repeating steps ii) to iv) until a liquid phase A2 comprising at least 95% by weight of bis(fluorosulfonyl)imide is obtained. As specified in the present application, during step iii) the hydrofluoric acid will react with the bis(halosulfonyl)imide to form bis(fluorosulfonyl)imide. Thus, during the implementation of the method, said liquid phase A2 will become concentrated in bis(fluorosulfonyl)imide. The weight content of bis(fluorosulfonyl)imide in said liquid phase A2 will gradually increase and the weight content of bis(halosulfonyl)imide in said liquid phase A2 will conversely gradually decrease. Advantageously, steps ii) to iv) are repeated until a liquid phase A2 comprising at least 95% by weight of bis(fluorosulfonyl)imide, preferably at least 96% by weight of bis(fluorosulfonyl)imide, more preferentially at least 97% by weight of bis(fluorosulfonyl)imide, in particular at least 98% by weight of bis(fluorosulfonyl)imide, more particularly at least 99% by weight of bis(fluorosulfonyl)imide, favorably at least 99.5% by weight of bis(fluorosulfonyl)imide, is obtained.

According to the present invention, the hydrofluoric acid, contained in the stream A1, and bis(halosulfonyl)imide, contained in the liquid phase A2, are mixed and brought into contact outside of said reactor. The mixing and contacting of the hydrofluoric acid and the bis(halosulfonyl)imide before their introduction into the reactor makes it possible to maximize their contact and thus to facilitate the reaction between them.

Said stream A1 can be in gaseous or liquid form. Thus, the hydrofluoric acid contained in this stream A1 can be in gaseous or liquid form. Preferably, when the hydrofluoric acid is in gaseous form, said stream A1 is in gaseous form. In this configuration, said stream A1 could also contain an inert gas, such as nitrogen or argon. Alternatively, when the hydrofluoric acid is in liquid form, said stream A1 is in liquid form.

Preferably, said stream A1 has an electrical conductivity of less than 30 mS/cm at ambient temperature, advantageously less than 25 mS/cm, preferably less than 20 mS/cm, more preferentially less than 15 mS/cm. The implementation of the process with a stream A1 having an electrical conductivity of greater than 30 mS/cm leads to a loss of overall yield of the reaction, both in the conversion of bis(halosulfonyl)imide and in the selectivity toward bis(fluorosulfonyl)imide. The measurement of the electrical conductivity is carried out on the basis of a stream A1 in liquid form. The electrical conductivity is measured using an inductive conductivity measurement cell according to the practice known to a person skilled in the art. The electrical conductivity of the stream A1 can be reduced, in order to achieve the values mentioned above according to techniques known to a person skilled in the art (distillation, passing through 3 to 5 Å molecular sieves or zeolites). Preferably, the measurement cell is coated with a material resistant to a corrosive medium, in particular resistant to hydrofluoric acid. The measurement of the conductivity of the stream A1 is carried out before the latter is introduced into said mixing device.

Said stream A1 can be vaporized, using a heat exchanger, to be converted to gaseous form before its introduction into said mixing device.

Preferably, said liquid phase A2 or said stream A1 when the latter is in liquid form is introduced into said at least one mixing device in the form of droplets. The size of the droplets may vary depending on the mixing device. However, said liquid phase A2 is introduced into said mixing device in the form of droplets, the diameter of which is between 10 and 500 μm. Above 500 μm, the reaction between said stream A1 and said liquid phase A2 is disfavored.

According to a particular embodiment, said stream A1 is in gaseous form. In this case, said at least one mixing device is preferably a water scrubber. The term “water scrubber” may also be referred to as a gas jet scrubber, hydro-ejector or Venturi gas scrubber. Said water scrubber comprises a chamber and a leg connected to one another. Said stream A1 containing hydrofluoric acid in gaseous form is introduced into said chamber of the water scrubber. Said liquid phase A2 comprising the bis(halosulfonyl)imide is also introduced into said chamber of the water scrubber. Said liquid phase A2 remains in liquid form when it is introduced into said chamber of the water scrubber and during its residence therein. In particular, in this configuration mode, said stream A1 and said liquid phase A2 are therefore mixed and brought into contact within said chamber of the water scrubber. Contact between the hydrofluoric acid and the bis(halosulfonyl)imide takes place in said chamber of the water scrubber. Preferably, said liquid phase A2 is introduced into said chamber of the water scrubber in the form of droplets. This can be carried out using a plurality of nozzles. The size of the droplets may vary depending on the size of the water scrubber and/or the chamber of the water scrubber. The type of nozzles depends on the size of the droplets to be generated. It is common practice for a person skilled in the art to choose the type of nozzles to be used in order to achieve a given size of droplets. Said liquid phase A2 is introduced into the water scrubber, i.e. into said chamber of the water scrubber, in the form of droplets, the diameter of which is between 10 and 500 μm. Above 500 μm, the reaction between said stream A1 and said liquid phase A2 is disfavored. The mixing and contacting of the stream A1 and the liquid phase A2 generates a two-phase gas/liquid mixture which supplies said leg of the water scrubber. Said two-phase gas/liquid mixture corresponds to said reaction mixture B. Said leg of the water scrubber makes it possible to store said reaction mixture B before it is introduced into the reactor. Thus, the leg of the water scrubber is directly connected to the inlet of said reactor.

According to another preferred embodiment, said at least one mixing device is a static mixer. In this embodiment, said stream A1 is in liquid or gaseous form but preferably said stream A1 is in liquid form. The use of the stream A1 in liquid form makes it possible to avoid an expensive step of vaporization thereof.

Preferably, in the static mixer, the liquid phase A2 and the stream A1, both in liquid form, are finely mixed which makes it possible to maximize the contact between the hydrofluoric acid contained in the stream A1 and the bis(halosulfonyl)imide contained in the liquid phase A2 and thus to facilitate the reaction between the two compounds. The reaction between these two compounds is initiated inside the static mixer. Thus, at the outlet of the static mixer, the mixture obtained is the reaction mixture B as described in the present application. The reaction mixture B formed is thus sent back to said reactor.

Preferably, said stream A1 in liquid form is introduced into the static mixer in the form of droplets. This can be carried out using a plurality of nozzles. The size of the droplets may vary depending on the size of the static mixer. The type of nozzles depends on the size of the droplets to be generated. It is common practice for a person skilled in the art to choose the type of nozzles to be used in order to achieve a given size of droplets. Thus, preferably, said stream A1 is introduced into the static mixer in the form of droplets, the diameter of which is between 10 and 500 μm. Above 500 μm, the reaction between said stream A1 and said liquid phase A2 is disfavored.

In this embodiment, said at least one mixing device may comprise a plurality of static mixers, for example two or more static mixers. When the mixing device comprises a plurality of static mixers, these are arranged in series. Preferably, in this case, said stream A1 supplies each of the static mixers while the liquid phase A2 supplies the first static mixer. The reaction mixture B formed in the first static mixer then supplies the second static mixer arranged in series with respect to the first static mixer. The reaction mixture B formed in each static mixer supplies the next one, up to the last static mixer, which is itself connected to said reactor.

According to a preferred embodiment, during step iii), a compound of formula HX is produced, X being Cl, Br or I and the reaction mixture B comprises, besides bis(fluorosulfonyl)imide, said compound HX. The compound HX is HCl when the bis(halosulfonyl)imide is bis(chlorosulfonyl)imide. The compound HX is HBr when the bis(halosulfonyl)imide is bis(bromosulfonyl)imide. The compound HX is HI when the bis(halosulfonyl)imide is bis(iodosulfonyl)imide.

Thus, the reaction mixture B introduced into said reactor comprises HX, bis(halosulfonyl)imide that has not reacted, bis(fluorosulfonyl)imide and optionally HF. Once reintroduced into said reactor, the reaction mixture B is mixed with said liquid phase A2. If the reaction mixture B comprises unreacted HF, said liquid phase A2 will also contain HF which will be able to react in the reactor with the bis(halosulfonyl)imide also present in the liquid phase A2. Thus, the liquid phase A2 may have a weight content of HF of less than 10%, advantageously less than 9%, preferably less than 8%, more preferentially less than 7%, in particular less than 6%, more particularly less than 5%, favorably less than 4%, advantageously favorably less than 3%, preferentially favorably less than 2%, particularly favorably less than 1% on the basis of the total weight of the liquid phase A2.

According to a preferred embodiment, said process comprises a step iv″) subsequent to step iv) during which the compound of formula HX is removed from said reactor. The removal of the compound HX can be carried out continuously. The compound HX is in gaseous form whereas the bis(fluorosulfonyl)imide and bis(halosulfonyl)imide compounds are in liquid form. The compound HX is thus found in gaseous form in the headspace of said reactor and can thus be easily separated from the other products of the reaction.

According to another aspect of the present invention, a plant is provided. Said plant makes it possible to carry out said bis(fluorosulfonyl)imide preparation process according to the present invention. Preferably, said plant comprises:
a reactor containing a liquid phase A2 comprising bis(halosulfonyl)imide;
a feed line for said liquid phase A2 connected to said reactor;
at least one mixing device connected to the inlet of said reactor;
a hydrofluoric acid feed line connected to the inlet of said mixing device;
a pump connected to the outlet of said reactor;
an outlet line configured to extract the gases contained in the headspace of said reactor; and
a pipe connecting said pump to said mixing device; and
optionally a heat exchanger positioned on said pipe and connected to said mixing device and to said pump.

Preferably, the pipe connects said pump to the inlet of said mixing device. Preferably, the outlet of said at least one mixing device is connected to the inlet of said reactor, in particular by means of a second pipe.

Preferably, the feed line for the stream A1 and said pipe connecting said pump to said mixing device are configured so as to allow said mixing device to be supplied co-currently.

Said reactor may have a jacket to improve the heat exchanges. Said plant may also include an outlet line for recovering the bis(fluorosulfonyl)imide. Preferably, this outlet line is positioned between the pump and said mixing device or between the pump and the heat exchanger if the plant comprises a heat exchanger.

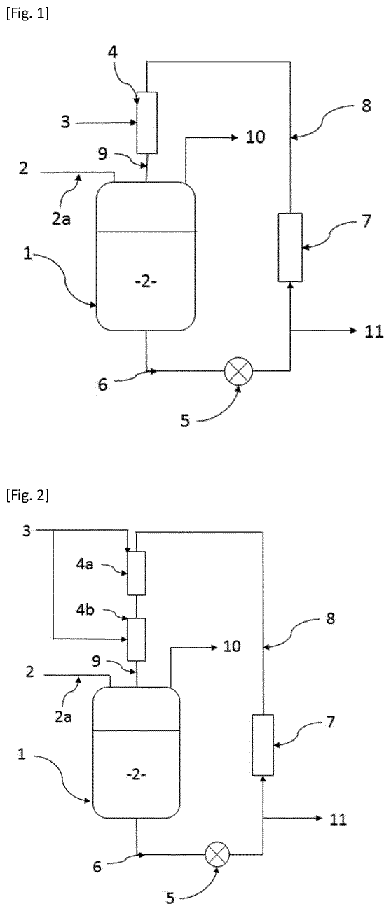

FIG. 1 illustrates a particular embodiment of a plant for implementing the preparation process described above. The reactor 1 contains a liquid phase 2 comprising bis(chlorosulfonyl)imide. The liquid phase 2 is introduced by the line 2a into said reactor 1. This introduction is prior to carrying out the fluorination reaction. The liquid phase 2 is withdrawn from the reactor 1 by a pump 5 connected to said reactor via a pipe 6. The liquid phase 2 supplies a heat exchanger 7 configured to keep the temperature of this liquid phase constant. A pipe 8 connects the heat exchanger 7 to the mixing device 4. The liquid phase 2 supplies said mixing device 4 via said pipe 8. Said mixing device 4 is also supplied with hydrofluoric acid 3 in gaseous or liquid form. A pipe 9 makes it possible to connect the outlet of the mixing device 4 to the inlet of the reactor 1. Said mixing device 4 may be a water scrubber or a static mixer as described in the present application. FIG. 2 illustrates another particular embodiment of a plant for implementing the preparation process described above. In this embodiment illustrated in FIG. 2, the plant comprises two mixing devices 4a, 4b arranged in series. This configuration is particularly advantageous when the mixing device is a static mixer. Each mixing device 4a, 4b is supplied with hydrofluoric acid 3. The flow leaving the mixing device 4a is introduced into the mixing device 4b. The flow leaving the mixing device 4b supplies the reactor 1 via the pipe 9.

In these two embodiments illustrated in FIG. 1 and in FIG. 2, the reactor 1 also comprises an outlet line 10 for removing the gases contained in the headspace of the reactor, in particular for removing the HCl coproduced during the fluorination reaction when the bis(halosulfonyl)imide is bis(chlorosulfonyl)imide. When the process is finished, for example when the conversion of the bis(halosulfonyl)imide is sufficient or complete, the liquid phase 2 is withdrawn from the reactor 1 via the pipe 6 and the pump 5 as above. However, the liquid phase 2 is conveyed to an outlet line 11 to recover this liquid phase enriched in bis(fluorosulfonyl)imide. The latter can be purified or used in another process without additional treatment. The implementation of the present process in batch mode is illustrated in FIG. 1 and FIG. 2.

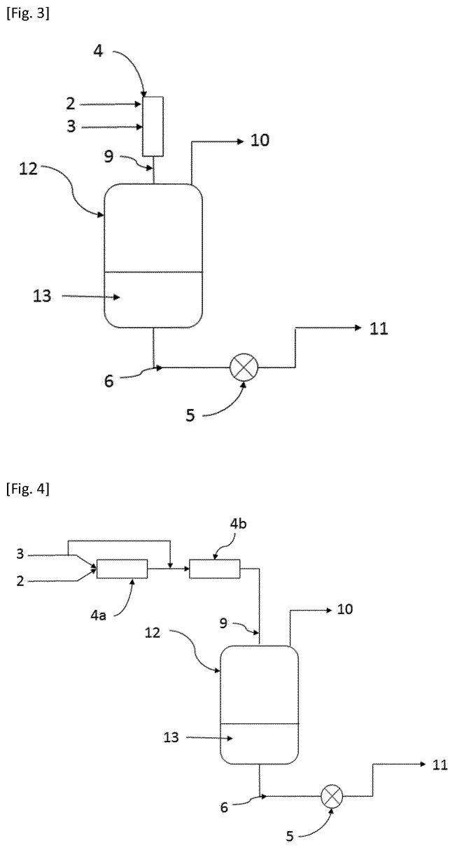

According to another aspect of the present invention, an alternative bis(fluorosulfonyl)imide preparation process is provided. In this other aspect of the invention, said process is preferably carried out continuously, i.e. the bis(fluorosulfonyl)imide is recovered continuously. This embodiment is illustrated in FIG. 3 and FIG. 4.

The process for preparing bis(fluorosulfonyl)imide comprises the steps of:

i′)—providing a stream A1 comprising hydrofluoric acid;
providing a liquid phase A2 comprising bis(halosulfonyl)imide;
providing at least one mixing device and a separator, said mixing device being connected to the inlet of said separator;

ii′) continuously supplying said at least one mixing device with said liquid phase A2 and with said stream A1;

iii′) bringing, in said mixing device, said liquid phase A2 into contact with said stream A1, in order to form a reaction mixture C comprising bis(fluorosulfonyl)imide;

iv′) introducing the reaction mixture C produced in step iii′) into said separator.

Preferably, the bis(fluorosulfonyl)imide within the reaction mixture C is in liquid form.

Preferably, said stream A1 supplies said mixing device continuously.

Preferably, said liquid phase A2 comprises bis(halosulfonyl)imide but is free of organic solvent. Thus, step iii′) of fluorinating the bis(halosulfonyl)imide to bis(fluorosulfonyl)imide is carried out in the absence of organic solvent.

According to an alternative particular embodiment, said liquid phase A2 comprises bis(halosulfonyl)imide and an organic solvent. The organic solvent SO1 can be chosen from esters, nitriles, ethers, aromatic solvents, carbonates, cyclic or heterocyclic solvents and mixtures thereof. Preferably, the organic solvent SO1 is chosen from the group consisting of methyl acetate, butyl acetate, ethyl acetate, propyl acetate, isopropyl acetate, butyronitrile, valeronitrile, benzonitrile, diisopropyl ether, 2-methoxy-2-methylbutane, cyclopentyl methyl ether, benzene, toluene, chlorobenzene, dichlorobenzene, xylenes, ethylbenzene, 1,4-dioxane, dimethyl carbonate, ethylene carbonate, sulfolane and mixtures thereof.

The hydrofluoric acid contained in said stream A1 reacts with the bis(halosulfonyl)imide contained in said liquid phase A2 to form the bis(fluorosulfonyl)imide. The bis(halosulfonyl)imide may be bis(chlorosulfonyl)imide, bis(bromosulfonyl)imide or bis(iodosulfonyl)imide or a mixture thereof. Preferably, in the present application, the bis(halosulfonyl)imide is bis(chlorosulfonyl)imide.

Preferably, the hydrofluoric acid is anhydrous hydrofluoric acid. In the context of the invention, the term “anhydrous hydrofluoric acid” is understood to mean HF containing less than 500 ppm of water, preferably less than 300 ppm of water and preferably less than 200 ppm of water. Preferably, step iii) is carried out under pressure and temperature conditions so as to keep the bis(halosulfonyl)imide and the bis(fluorosulfonyl)imide produced in liquid form.

Thus, step iii′) may be carried out at atmospheric pressure or at a pressure greater than atmospheric pressure. Preferably, step iii′) may be carried out at a pressure of less than 10 bara, advantageously at a pressure of less than 9 bara, preferably of less than 8 bara, more preferentially of less than 7 bara, in particular of less than 6 bara.

Step iii′) may be carried out at a temperature above 0° C., advantageously above 5° C., preferably above 10° C., more preferentially above 15° C.

Preferably, step iii′) is carried out at a temperature below 150° C., advantageously below 140° C., preferably below 130° C., more preferentially below 120° C., in particular below 110° C., more particularly below 100° C., favorably below 90° C., advantageously favorably below 80° C., preferentially favorably below 70° C., more preferentially favorably below 60° C., particularly favorably below 50° C.

Thus, step iii′) may be carried out at a temperature above 0° C., advantageously above 5° C., preferably above 10° C., more preferentially above 15° C.; and at a temperature below 150° C., advantageously below 140° C., preferably below 130° C., more preferentially below 120° C., in particular below 110° C., more particularly below 100° C., favorably below 90° C., advantageously favorably below 80° C., preferentially favorably below 70° C., more preferentially favorably below 60° C., particularly favorably below 50° C.

Preferably, step iii′) may be carried out at a temperature above 0° C., advantageously above 5° C., preferably above 10° C., more preferentially above 15° C.; and at a temperature below 150° C., advantageously below 140° C., preferably below 130° C., more preferentially below 120° C., in particular below 110° C., more particularly below 100° C., favorably below 90° C., advantageously favorably below 80° C., preferentially favorably below 70° C., more preferentially favorably below 60° C., particularly favorably below 50° C.; and at atmospheric pressure.

Preferably, step iii′) may be carried out at a temperature above 0° C., advantageously above 5° C., preferably above 10° C., more preferentially above 15° C.; and at a temperature below 150° C., advantageously below 140° C., preferably below 130° C., more preferentially below 120° C., in particular below 110° C., more particularly below 100° C., favorably below 90° C., advantageously favorably below 80° C., preferentially favorably below 70° C., more preferentially favorably below 60° C., particularly favorably below 50° C.; and at a pressure of greater than 1 bara; and of less than 10 bara, advantageously at a pressure of less than 9 bara, preferably less than 8 bara, more preferentially less than 7 bara, in particular less than 6 bara.

Preferably, during steps ii′) and iii′), the temperature of said liquid phase A2 is kept substantially constant. In the present application, the term “substantially constant” is understood to mean a temperature variation of at most 5° C. in absolute value, preferably of at most 3° C. in absolute value, more preferentially still of at most 2° C. in absolute value, or in particular of at most 1° C. in absolute value.

Thus, during steps ii′) and iii′), the temperature of said liquid phase A2 varies by at most 5° C. in absolute value, preferably by at most 3° C. in absolute value, more preferentially still by at most 2° C. in absolute value, or in particular by at most 1° C. in absolute value.

Preferably, in step iii′), the rate of introduction of the hydrofluoric acid contained in said stream A1 into said at least one mixing device is at least 1 mol of HF/mole of bis(halosulfonyl)imide/hour, advantageously at least 5 mol of HF/mole of bis(halosulfonyl)imide/hour, preferably at least 10 mol of HF/mole of bis(halosulfonyl)imide/hour, more preferentially at least 20 mol of HF/mole of bis(halosulfonyl)imide/hour, in particular at least 30 mol of HF/mole of bis(halosulfonyl)imide/hour, more particularly at least 40 mol of HF/mole of bis(halosulfonyl)imide/hour, favorably at least 50 mol of HF/mole of bis(halosulfonyl)imide/hour.

In particular, in step iii′), the rate of introduction of the hydrofluoric acid contained in said stream A1 into said at least one mixing device is at most 300 mol of HF/mole of bis(halosulfonyl)imide/hour, advantageously at most 250 mol of HF/mole of bis(halosulfonyl)imide/hour, preferably at most 200 mol of HF/mole of bis(halosulfonyl)imide/hour, in particular at most 150 mol of HF/mole of bis(halosulfonyl)imide/hour, more particularly at most 125 mol of HF/mole of bis(halosulfonyl)imide/hour, favorably at most 100 mol of HF/mole of bis(halosulfonyl)imide/hour.

Thus, in step iii′), the rate of introduction of the hydrofluoric acid contained in said stream A1 into said at least one mixing device is at least 1 mol of HF/mole of bis(halosulfonyl)imide/hour, advantageously at least 5 mol of HF/mole of bis(halosulfonyl)imide/hour, preferably at least 10 mol of HF/mole of bis(halosulfonyl)imide/hour, more preferentially at least 20 mol of HF/mole of bis(halosulfonyl)imide/hour, in particular at least 30 mol of HF/mole of bis(halosulfonyl)imide/hour, more particularly at least 40 mol of HF/mole of bis(halosulfonyl)imide/hour, favorably at least 50 mol of HF/mole of bis(halosulfonyl)imide/hour; and at most 300 mol of HF/mole of bis(halosulfonyl)imide/hour, advantageously at most 250 mol of HF/mole of bis(halosulfonyl)imide/hour, preferably at most 200 mol of HF/mole of bis(halosulfonyl)imide/hour, in particular at most 150 mol of HF/mole of bis(halosulfonyl)imide/hour, more particularly at most 125 mol of HF/mole of bis(halosulfonyl)imide/hour, favorably at most 100 mol of HF/mole of bis(halosulfonyl)imide/hour.

In particular, in step iii′), the rate of introduction of the hydrofluoric acid contained in said stream A1 into said at least one mixing device is at least 1 mol of HF/mole of bis(chlorosulfonyl)imide/hour, advantageously at least 5 mol of HF/mole of bis(chlorosulfonyl)imide/hour, preferably at least 10 mol of HF/mole of bis(chlorosulfonyl)imide/hour, more preferentially at least 20 mol of HF/mole of bis(chlorosulfonyl)imide/hour, in particular at least 30 mol of HF/mole of bis(chlorosulfonyl)imide/hour, more particularly at least 40 mol of HF/mole of bis(chlorosulfonyl)imide/hour, favorably at least 50 mol of HF/mole of bis(chlorosulfonyl)imide/hour.

More particularly, in step iii′), the rate of introduction of the hydrofluoric acid contained in said stream A1 into said at least one mixing device is at most 300 mol of HF/mole of bis(chlorosulfonyl)imide/hour, advantageously at most 250 mol of HF/mole of bis(chlorosulfonyl)imide/hour, preferably at most 200 mol of HF/mole of bis(chlorosulfonyl)imide/hour, in particular at most 150 mol of HF/mole of bis(chlorosulfonyl)imide/hour, more particularly at most 125 mol of HF/mole of bis(chlorosulfonyl)imide/hour, favorably at most 100 mol of HF/mole of bis(chlorosulfonyl)imide/hour.

Thus, in step iii′), the rate of introduction of the hydrofluoric acid contained in said stream A1 into said at least one mixing device is at least 1 mol of HF/mole of bis(chlorosulfonyl)imide/hour, advantageously at least 5 mol of HF/mole of bis(chlorosulfonyl)imide/hour, preferably at least 10 mol of HF/mole of bis(chlorosulfonyl)imide/hour, more preferentially at least 20 mol of HF/mole of bis(chlorosulfonyl)imide/hour, in particular at least 30 mol of HF/mole of bis(chlorosulfonyl)imide/hour, more particularly at least 40 mol of HF/mole of bis(chlorosulfonyl)imide/hour, favorably at least 50 mol of HF/mole of bis(chlorosulfonyl)imide/hour; and at most 300 mol of HF/mole of bis(chlorosulfonyl)imide/hour, advantageously at most 250 mol of HF/mole of bis(chlorosulfonyl)imide/hour, preferably at most 200 mol of HF/mole of bis(chlorosulfonyl)imide/hour, in particular at most 150 mol of HF/mole of bis(chlorosulfonyl)imide/hour, more particularly at most 125 mol of HF/mole of bis(chlorosulfonyl)imide/hour, favorably at most 100 mol of HF/mole of bis(chlorosulfonyl)imide/hour.

The rate of introduction of the hydrofluoric acid mentioned above makes it possible to avoid losses of HF, in particular when the latter is introduced in gaseous form. This therefore makes it possible to improve the overall efficiency of the process.

In addition, the rate of introduction of the HF can be controlled so as to maintain a low stationary concentration of HF in the mixing device. The HF will then be consumed immediately in the fluorination reaction and the molar ratio between the HF and the bis(halosulfonyl)imide will be close to stoichiometry.

Thus, according to a preferred embodiment, step iii′) is carried out with an HF/[bis(halosulfonyl)imide] molar ratio of at least 2.0, preferably of at least 2.05, in particular of at least 2.1. Preferably, step iii′) is carried out with an HF/[bis(halosulfonyl)imide] molar ratio of at most 3.5, preferably of at most 3.0, in particular of at most 2.5. Thus, step iii′) is carried out with an HF/[bis(halosulfonyl)imide] molar ratio of at least 2.0, preferably of at least 2.05, in particular of at least 2.1; and of at most 3.5, preferably of at most 3.0, in particular of at most 2.5. Preferably, step iii′) is carried out with an HF/[bis(chlorosulfonyl)imide] molar ratio of at least 2.0, preferably of at least 2.05, in particular of at least 2.1. Preferably, step iii′) is carried out with an HF/[bis(chlorosulfonyl)imide] molar ratio of at most 3.5, preferably of at most 3.0, in particular of at most 2.5. Thus, step iii′) is carried out with an HF/[bis(chlorosulfonyl)imide] molar ratio of at least 2.0, preferably of at least 2.05, in particular of at least 2.1; and of at most 3.5, preferably of at most 3.0, in particular of at most 2.5.

Said stream A1 can be in gaseous or liquid form. Thus, the hydrofluoric acid contained in this stream A1 can be in gaseous or liquid form. However, in this aspect of the invention where the process is carried out continuously, preferably, said stream A1 is in liquid form, i.e. the hydrofluoric acid is in liquid form.

Preferably, said stream A1 has an electrical conductivity of less than 30 mS/cm at ambient temperature, advantageously less than 25 mS/cm, preferably less than 20 mS/cm, more preferentially less than 15 mS/cm. The implementation of the process with a stream A1 having an electrical conductivity of greater than 30 mS/cm leads to a loss of overall yield of the reaction, both in the conversion of bis(halosulfonyl)imide and in the selectivity toward bis(fluorosulfonyl)imide. The measurement of the electrical conductivity is carried out on the basis of a stream A1 in liquid form. The electrical conductivity is measured using an inductive conductivity measurement cell according to the practice known to a person skilled in the art. The electrical conductivity of the stream A1 can be reduced in order to achieve the values mentioned above according to techniques known to a person skilled in the art (distillation, passing through 3 to 5 Å molecular sieves or zeolites). Preferably, the measurement cell is coated with a material resistant to a corrosive medium, in particular resistant to hydrofluoric acid. The measurement of the conductivity of the stream A1 is carried out before the latter is introduced into said mixing device.

Preferably, said stream A1 is in liquid form and said at least one mixing device is a static mixer. Preferably, in the static mixer, the liquid phase A2 and the stream A1, both in liquid form, are finely mixed which makes it possible to maximize the contact between the hydrofluoric acid contained in the stream A1 and the bis(halosulfonyl)imide contained in the liquid phase A2 and thus to facilitate the reaction between the two compounds. The reaction between these two compounds is initiated and completed inside the static mixer. Thus, at the outlet of the static mixer, the mixture obtained is the reaction mixture C.

Preferably, said stream A1 in liquid form is introduced into the static mixer in the form of droplets. This can be carried out using a plurality of nozzles. The size of the droplets may vary depending on the size of the static mixer. The type of nozzles depends on the size of the droplets to be generated. It is common practice for a person skilled in the art to choose the type of nozzles to be used in order to achieve a given size of droplets. Thus, preferably, said stream A1 is introduced into the static mixer in the form of droplets, the diameter of which is between 10 and 500 μm. Above 500 μm, the reaction between said stream A1 and said liquid phase A2 is disfavored.

According to a preferred embodiment, during step iii′), a compound of formula HX is produced, X being Cl, Br or I and the reaction mixture C comprises, besides bis(fluorosulfonyl)imide, said compound HX. The compound HX is HCl when the bis(halosulfonyl)imide is bis(chlorosulfonyl)imide. The compound HX is HBr when the bis(halosulfonyl)imide is bis(bromosulfonyl)imide. The compound HX is HI when the bis(halosulfonyl)imide is bis(iodosulfonyl)imide. The reaction mixture C formed is thus sent to said reactor. Preferably, the reaction mixture C introduced into said separator is free of bis(halosulfonyl)imide, i.e. the reaction mixture C contains less than 1000 ppm by weight of bis(halosulfonyl)imide, preferably less than 500 ppm, in particular less than 100 ppm, more particularly less than 50 ppm by weight of bis(halosulfonyl)imide. Preferably, the reaction mixture C is free of HF, i.e. the reaction mixture C contains less than 5000 ppm by weight of HF, preferably less than 1000 ppm, in particular less than 500 ppm, more particularly less than 100 ppm by weight of HF. In this embodiment, said at least one mixing device may comprise a plurality of static mixers, for example two or more static mixers. When the mixing device comprises a plurality of static mixers, these are arranged in series. Preferably, in this case, said stream A1 supplies each of the static mixers while the liquid phase A2 supplies the first static mixer. The reaction mixture C formed in the first static mixer then supplies the second static mixer arranged in series with respect to the first static mixer. The reaction mixture C formed in each static mixer supplies the next one, up to the last static mixer, which is itself connected to said separator.

According to a preferred embodiment, said process comprises a step iv″) subsequent to step iv′) during which the compound of formula HX is removed from said separator. Thus during step iv″), the reaction mixture C comprises HX and the bis(fluorosulfonyl)imide is separated to form a gas stream comprising HX and a liquid stream D comprising bis(fluorosulfonyl)imide. The removal of the compound HX can be carried out continuously. In said separator which contains the reaction mixture C, the compound HX, preferably HCl when the bis(halosulfonyl)imide is bis(chlorosulfonyl)imide, is in gaseous form while the bis(fluorosulfonyl)imide compound is in liquid form. The compound HX is thus found in gaseous form in the headspace of said reactor and can thus be easily separated from the bis(fluorosulfonyl)imide. The liquid stream D is preferably withdrawn from said separator continuously during a step v′). This step v′) is carried out simultaneously with step iv″). The liquid stream D comprises more than 99% by weight of bis(fluorosulfonyl)imide, preferably more than 99.5% by weight of bis(fluorosulfonyl)imide, in particular more than 99.9% by weight of bis(fluorosulfonyl)imide on the basis of the total weight of said liquid stream D.

In this aspect of the present invention, a plant for implementing the process is provided.

Preferably, said plant comprises:
a separator and at least one mixing device, the outlet of said mixing device being connected to the inlet of said separator;
a feed line for a liquid phase A2 comprising bis(halosulfonyl)imide connected to the inlet of said mixing device;
a feed line for a stream A1 comprising hydrofluoric acid and connected to the inlet of said mixing device;
a pump connected to the outlet of said separator;
an outlet line configured to extract the gases contained in the headspace of said separator; and
an outlet line connected to said pump.

Preferably, said outlet line connected to said pump is configured to continuously withdraw the bis(fluorosulfonyl)imide. Preferably, said at least one mixing device is equipped with a jacket.

Preferably, the feed line for the liquid phase A2 and the feed line for the stream A1 are configured so as to allow said mixing device to be supplied co-currently.

FIG. 3 illustrates a particular embodiment of a plant for the continuous implementation of the preparation process described above. The liquid phase 2 comprising the bis(chlorosulfonyl)imide and the hydrofluoric acid 3 continuously supply the mixing device 4. The mixture obtained in the mixing device 4, i.e. the reaction mixture C according to the present application, is introduced into the separator 12 through the pipe 9. Said separator 12 is connected to a pump 5 via a pipe 6. The pump 5 makes it possible to continuously withdraw the liquid phase 13 contained in the separator 12. The liquid phase 13 comprises the bis(fluorosulfonyl)imide. The separator 12 also comprises an outlet line 10 for removing the gases contained in the headspace of the reactor, i.e. the HCl coproduced during the reaction. An outlet line 11 connected to the pump 5 makes it possible to recover the bis(fluorosulfonyl)imide.

FIG. 4 illustrates a particular embodiment of a plant for the continuous implementation of the preparation process described above in which two mixing devices 4a, 4b are arranged in series. This configuration is particularly advantageous when the mixing device is a static mixer. The hydrofluoric acid directly supplies each of the mixing devices 4a and 4b. The liquid phase 2 comprising the bis(chlorosulfonyl)imide supplies the first mixing device continuously. The flow leaving the second mixing device 4b supplies the separator 12.

According to another aspect, the present invention provides a process for preparing lithium bis(fluorosulfonyl)imide salt comprising the steps:

a) carrying out the bis(fluorosulfonyl)imide preparation process according to the present invention;

b) bringing the bis(fluorosulfonyl)imide into contact with a composition comprising at least one lithium salt in order to form said lithium bis(fluorosulfonyl)imide salt.

The present lithium bis(fluorosulfonyl)imide salt preparation process is carried out irrespective of the bis(fluorosulfonyl)imide preparation process used, i.e. continuous or batch. According to a preferred embodiment, the composition comprising at least one lithium salt is an aqueous composition, preferably an aqueous suspension or an aqueous solution.

According to another preferred embodiment, the composition comprising at least one lithium salt is a solid composition, preferably the composition consists of at least one solid lithium salt. In particular, the bis(fluorosulfonyl)imide is added to a container comprising the composition comprising at least one lithium salt. The container may be a reactor, preferably comprising at least one stirring system. The elements that make it possible to introduce the composition obtained in step b) are preferably resistant to HF.

According to one embodiment, the lithium salt is chosen from the group consisting of LiOH, LiOH.H₂O, LiHCO₃, Li₂CO₃, LiCl, and mixtures thereof. Preferably, the lithium salt is Li₂CO₃.

The composition, when it is an aqueous composition comprising at least one lithium salt, may be prepared by any conventional means for preparing an alkaline aqueous composition. This may be for example the dissolving of the lithium salt in ultrapure or deionized water, with stirring.

To determine the amount of lithium salt to be introduced, it is typically possible to carry out an analysis of the total acidity of the mixture to be neutralized.

According to one embodiment, step b) is such that:
the molar ratio of the lithium salt divided by the number of basicities of said salt relative to the bis(fluorosulfonyl)imide is greater than or equal to 1, preferably less than 5, preferably less than 3, preferentially between 1 and 2; and/or
the weight ratio of the lithium salt to the weight of water in the aqueous composition is between 0.1 and 2, preferably between 0.2 and 1, preferably between 0.3 and 0.7.

For example, the Li₂CO₃ salt has a number of basicities equal to 2.

Step b) of the process according to the invention can be carried out at a temperature less than or equal to 40° C., preferably less than or equal to 30° C., preferentially less than or equal to 20° C., and in particular less than or equal to 15° C.

According to one embodiment, the process according to the invention comprises an additional step of filtering the composition obtained in step b), resulting in a filtrate F and a cake G. The lithium bis(fluorosulfonyl)imide salt may be contained in the filtrate F and/or in the cake G. The filtrate F may be subjected to at least one step of extraction with an organic solvent S typically sparingly soluble in water, in order to extract the lithium bis(fluorosulfonyl)imide salt into an organic phase. The extraction step typically results in the separation of an aqueous phase and an organic phase. In the context of the invention, and unless otherwise indicated, the term “sparingly soluble in water” is intended to mean a solvent of which the solubility in water is less than 5% by weight. The abovementioned organic solvent S is in particular chosen from the following families: esters, nitriles, ethers, chlorinated solvents and aromatic solvents, and mixtures thereof. Preferably, the organic solvent S is chosen from dichloromethane, ethyl acetate, butyl acetate, tetrahydrofuran and diethyl ether, and mixtures thereof. In particular, the organic solvent S is butyl acetate. For each extraction, the weight amount of organic solvent used may vary between ⅙ and 1 times the weight of the filtrate F. The number of extractions may be between 2 and 10. Preferably, the organic phase, resulting from the extraction(s), has a weight content of lithium bis(fluorosulfonyl)imide salt ranging from 5% to 40% by weight. The separated organic phase (obtained at the end of the extraction) may then be concentrated to reach a concentration of lithium bis(fluorosulfonyl)imide salt of between 30% and 60%, preferably between 40% and 50% by weight, it being possible for said concentration to be achieved by any evaporation means known to those skilled in the art.

The abovementioned cake G may be washed with an organic solvent S′ chosen from the following families: esters, nitriles, ethers, chlorinated solvents and aromatic solvents, and mixtures thereof. Preferably, the organic solvent S′ is chosen from dichloromethane, ethyl acetate, butyl acetate, tetrahydrofuran, acetonitrile and diethyl ether, and mixtures thereof. In particular, the organic solvent S′ is butyl acetate. The weight amount of organic solvent S′ used may range between 1 and 10 times the weight of the cake. The total amount of organic solvent S′ intended for the washing may be used in a single portion or in several portions for the purpose notably of optimizing the dissolution of the lithium bis(fluorosulfonyl)imide salt. Preferably, the organic phase, resulting from the washing(s) of the cake G, has a weight content of lithium bis(fluorosulfonyl)imide salt ranging from 5% to 20% by weight. The separated organic phase resulting from the washing(s) of the cake G may then be concentrated to reach a concentration of lithium bis(fluorosulfonyl)imide salt of between 30% and 60%, preferably between 40% and 50% by weight, it being possible for said concentration to be achieved by any evaporation means known to those skilled in the art. According to one embodiment, the organic phases resulting from the extraction(s) of the filtrate F and from the washing(s) of the cake G may be pooled, before a concentration step.

### EXAMPLE

65 kg of liquid bis(chlorosulfonyl)imide (HCSI) and 6.5 kg of liquid 1,4-dioxane are introduced into an unstirred 100-liter reactor. The weight ratio between the 1,4-dioxane and the HCSI is 10%. The medium comprising HCSI and 1,4-dioxane is brought to 50° C., prior to the introduction of the hydrofluoric acid. A pumping device makes it possible to withdraw the medium present in the reactor through the bottom of the latter and to re-introduce it into the reactor through the top of the reactor. This pumping loop operates throughout the reaction. The reaction is carried out by regulating the temperature of the reaction medium at 50° C. by means of an exchanger installed on this circulation loop. The latter also includes a static mixer which is also supplied with HF. This static mixer makes it possible to effectively mix, co-currently, the medium withdrawn from the reactor with HF before returning this mixture to the reactor. The HF is continuously introduced during the reaction. The total amount of HF introduced is 18.0 kg, which corresponds to an HF molar ratio relative to the HCSI of 3.0. The rate of introduction of the gaseous HF is regulated at 6.2 kg/h. The reaction time is 3 hours.

The reaction is accompanied by the formation of HCl which is continuously removed from the reactor. The gases leaving the reactor are sent to a water trap. When all the HF has been introduced, a stream of nitrogen with a flow rate of 1 m³/h is introduced into the reactor so as to strip the HF and HCl that may be dissolved in the reaction medium. This stripping is carried out for 2 h and the temperature of the medium is maintained at 50° C. The stripping gases leaving the reactor are also sent to a water trap. After stripping, the reactor contains 58.3 kg of crude bis(fluorosulfonyl)imide (HFSI). The composition of this crude HFSI is analyzed by NMR.

Composition of the crude HFSI in % by weight

| | |
|---|---|
| HFSI | 89.78 |
| FSO3H | 1.42 |
| FSO2NH2 | 0.45 |
| HF | 2.23 |
| 1,4-dioxane | 6.12 |

The conversion of the HCSI is complete and reaches 100%. The yield of HFSI is 91.2%.

1-17. (canceled)

18. A process for preparing bis(fluorosulfonyl)imide comprising the steps of:
i. providing a stream A1 comprising hydrofluoric acid;
a. providing a reactor containing a liquid phase A2 comprising bis(halosulfonyl)imide;
b. providing at least one mixing device connected to the inlet of said reactor;
ii. supplying said at least one mixing device with the liquid phase A2 and with said stream A1;
iii. bringing, in said mixing device, said liquid phase A2 into contact with said stream A1, in order to form a reaction mixture B comprising bis(fluorosulfonyl)imide; and
iv. introducing the reaction mixture B produced in step iii) into the liquid phase A2 of said reactor.

19. The process as claimed in claim 18, wherein the process is carried out in batch mode and the liquid phase A2 contained in said reactor is withdrawn to supply said at least one mixing device in step ii).

20. The process as claimed in claim 18, wherein said process comprises step v) of repeating steps ii) to iv) until a liquid phase A2 comprising at least 95% by weight of bis(fluorosulfonyl)imide is obtained.

21. The process as claimed in claim 18, wherein the hydrofluoric acid is in gaseous form and said at least one mixing device is a water scrubber.

22. The process as claimed in claim 18, wherein the hydrofluoric acid is in liquid form and said at least one mixing device is a static mixer.

23. A process for preparing bis(fluorosulfonyl)imide comprising the steps of:
i′) providing a stream A1 comprising hydrofluoric acid;
providing a liquid phase A2 comprising bis(halosulfonyl)imide;
providing at least one mixing device and a separator, said mixing device being connected to the inlet of said separator;
ii′) continuously supplying said at least one mixing device with the liquid phase A2 and with said stream A1;
iii′) bringing, in said mixing device, said liquid phase A2 into contact with said stream A1, in order to form a reaction mixture C comprising bis(fluorosulfonyl)imide; and
iv′) introducing the reaction mixture C produced in step iii′) into said separator.

24. The process as claimed in claim 23, wherein the hydrofluoric acid is in liquid form and said at least one mixing device is a static mixer.

25. The process as claimed in claim 23, wherein said stream A1 and said liquid phase A2 supply said mixing device co-currently.

26. The process as claimed in claim 23, wherein, during step iii) or during step iii′), a compound of formula HX is produced, X being Cl, Br or I and the reaction mixture B or the reaction mixture C comprises, besides bis(fluorosulfonyl)imide, said compound HX.

27. The process as claimed in claim 23, wherein said process comprises a step iv″) subsequent to step iv) during which the compound of formula HX is removed from said reactor or a step iv″) subsequent to step iv′) during which the compound of formula HX is removed from said separator.

28. The process as claimed in claim 23, wherein the rate of introduction of the hydrofluoric acid contained in said stream A1 into said at least one mixing device is at least 1 mol of HF/mole of bis(halosulfonyl)imide/hour.

29. The process as claimed in claim 23, wherein step iii) or step iii′) is carried out with an HF/[bis(halosulfonyl)imide] molar ratio of at least 2.0 and at most 3.0.

30. The process as claimed in claim 23, wherein the bis(halosulfonyl)imide compound is bis(chlorosulfonyl)imide.

31. The process as claimed in claim 23, wherein said stream A1 has an electrical conductivity of less than 30 mS/cm at ambient temperature.

32. A process for preparing a lithium bis(fluorosulfonyl)imide salt, comprising the steps:
a) carrying out the process for preparing the bis(fluorosulfonyl)imide as claimed in claim 17; and
b) bringing the bis(fluorosulfonyl)imide into contact with a composition comprising at least one lithium salt in order to form said lithium bis(fluorosulfonyl)imide salt.

33. A plant for carrying out the preparation process as claimed in claim 18 comprising:
a reactor containing a liquid phase A2 comprising bis(halosulfonyl)imide;
a feed line for said liquid phase A2 connected to said reactor;
at least one mixing device, the outlet of which is connected to the inlet of said reactor;
a feed line for a stream A1 comprising hydrofluoric acid and connected to the inlet of said mixing device;
a pump connected to the outlet of said reactor;
an outlet line configured to extract the gases contained in the headspace of said reactor;
a pipe connecting said pump to the inlet of said mixing device; and
optionally a heat exchanger positioned on said pipe and connected to said mixing device and to said pump.

34. The plant for carrying out the preparation process as claimed in claim 23 comprising:
a separator and at least one mixing device, the outlet of said at least one mixing device being connected to the inlet of said separator;
a feed line for a liquid phase A2 comprising bis(halosulfonyl)imide connected to the inlet of said mixing device;
a feed line for a stream A1 comprising hydrofluoric acid and connected to the inlet of said mixing device;
a pump connected to the outlet of said separator;
an outlet line configured to extract the gases contained in the headspace of said separator; and
an outlet line connected to said pump.
